(19) United States
(12) Patent Application Publication
(10) Pub. No.: US 2013/0127591 A1
(43) Pub. Date: May 23, 2013

(54) SECURE FACILITIES ACCESS

(71) Applicants: Ben-David Shay, Haifa (IL); Connell Jonathan Hudson, Corlandt_Manor, NY (US); Hoory Ron, Ramat Yishay (IL); Nahamoo David, Great Neck, NY (US); Sicconi Roberto, Ridgefield, CT (US)

(72) Inventors: Ben-David Shay, Haifa (IL); Connell Jonathan Hudson, Corlandt_Manor, NY (US); Hoory Ron, Ramat Yishay (IL); Nahamoo David, Great Neck, NY (US); Sicconi Roberto, Ridgefield, CT (US)

(73) Assignee: International Business Machines Corporation, Armonk, NY (US)

(21) Appl. No.: 13/300,588

(22) Filed: Nov. 20, 2011

(51) Int. Cl. G05B 19/00

(52) U.S. Cl. 340/5.52

(57) ABSTRACT

Method, system, and computer program product are provided for secure facilities access. The method may include: receiving an access request from a mobile device to a secure facility; authenticating a user using multifactor biometric authentication with data from the mobile device; obtaining data from one or more fixed sensor devices at a location in the physical vicinity of the secure facility; cross-validating data from the mobile device with data from the one or more fixed sensor devices; and granting access to the secure facility if the authentication of the user and the cross-validation are successful. The cross-validating may determine that the access request from the mobile device is made in the vicinity of the secure facility using data from the one or more fixed sensor devices.

### BACKGROUND

This invention relates to the field of secure facilities access. In particular, the invention relates to secure facilities access using multifactor biometric authentication.

Multifactor biometric authentication is used to verify a person's identity with high accuracy using several biometric factors (e.g., voiceprint, fingerprint, face, iris, etc.) as well as additional factors such as knowledge of private details.

Such authentication can be done using mobile devices or phones that are equipped with different sensors or using fixed sensors, by capturing the person's voice, image (face/iris), or other biometric features and sending them to a remote server for verification of an enrolled user.

One of the major usages of multifactor biometric authentication is for access control in high-security locations.

Existing biometric systems for physical access control are costly and require on-site installation of expensive equipment.

### BRIEF SUMMARY

According to a first aspect of the present invention there is provided a computer-implemented method for secure facilities access performed by a computerized device, comprising: receiving an access request from a mobile device to access a secure facility; authenticating a user using multifactor biometric authentication with data from the mobile device; obtaining data from one or more fixed sensor devices at a location in the physical vicinity of the secure facility; cross-validating data from the mobile device with data from the one or more fixed sensor devices; and granting access to the secure facility if the authentication of the user and the cross-validation are successful.

According to a second aspect of the present invention there is provided a computer program product for secure facilities access, the computer program product comprising: a computer readable non-transitory storage medium having computer readable program code embodied therewith, the computer readable program code comprising: computer readable program code configured to: receive an access request from a mobile device to access a secure facility; authenticate a user using multifactor biometric authentication with data from the mobile device; obtain data from one or more fixed sensor devices at a location in the physical vicinity of the secure facility; cross-validate data from the mobile device with data from the one or more fixed sensor devices; grant access to the secure facility if the authentication of the user and the cross-validation are successful.

According to a third aspect of the present invention there is provided a system for secure facilities access, comprising: a processor; a mobile device request receiving component for receiving an access request from a mobile device to access a secure facility; a multifactor biometric authentication component for authenticating a user using multifactor biometric authentication with data from the mobile device; a fixed sensor data receiving component for receiving data from one or more fixed sensor devices at a location in the physical vicinity of the secure facility; a cross-validation component for cross-validating data from the mobile device with data from the one or more fixed sensor devices; and a decision component for granting access to the secure facility if the authentication of the user and the cross-validation are successful.

According to a fourth aspect of the present invention there is provided a method of providing a service to a customer over a network, the service comprising: receiving an access request from a mobile device to access a secure facility; authenticating a user using multifactor biometric authentication data from the mobile device; obtaining data from one or more fixed sensor devices at a location in the physical vicinity of the secure facility; cross-validating data from the mobile device with data from the one or more fixed sensor devices; granting access to the secure facility if the authentication of the user and the cross-validation are successful.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a flow diagram of a method in accordance with the present invention; and

FIG. 4 is a flow diagram of a method in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system and computer program product are described in which secure facilities access is governed by a multifactor biometric authentication system accessed by a mobile device and locally validated to confirm that that the person being authenticated is indeed at that location. This cross-validation may be carried out by allowing a biometric authentication server real-time secure access to audio and video inputs from on site cameras and microphones. The inputs from such on site cameras and microphones may be cross-correlated with the audio and video captured at the same time by the mobile device.

Existing biometrics systems for physical access control are costly and require on-site installation of expensive equipment. The described system implements secure physical access by combining the use of the mobile device/smartphone with existing low cost equipment (camera, microphone) residing locally at the entrance of the secure location, without losing accuracy.

Accurate mobile multifactor biometric authentication may be carried out with a personal device and biometric server already deployed and where the user has already enrolled. The user may use the same mobile authentication mechanism when entering a multitude of different secure sites, without needing to re-enrol, or get to know a new system.

Cross-validation may be carried out in a range of levels from a simple manner with a single camera or microphone, to more sophisticated challenge and cross-authentication.

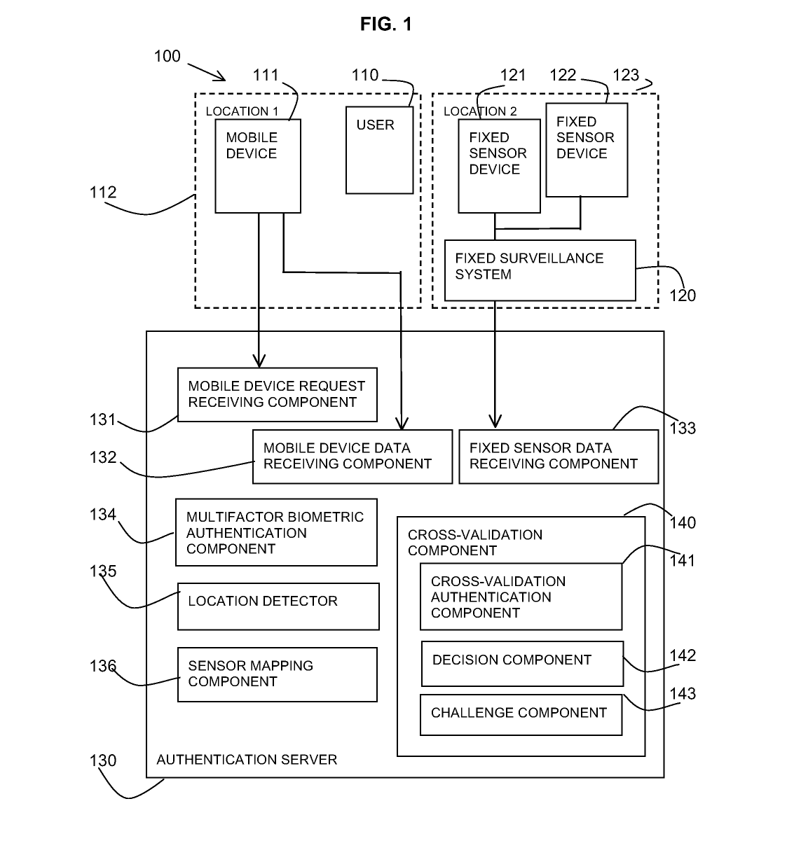

Referring to FIG. 1, a block diagram shows an embodiment of the described system for secure facilities access. A user 110 may arrive at a first location 112 and the user 110 may have a mobile device 111 such as a mobile phone, smartphone, or other portable electronic device.

The first location 112 may be in close proximity to a second location 123 of a secure facility to which the user 110 wishes to gain access, such as an entrance or access point to a secure location or facility or to security protected equipment.

The second location 123 may have one or more fixed sensor devices 121, 122. For example, these may be a camera, a microphone, or more sophisticated sensor devices. The second location 123 may have a fixed surveillance system 120 at the location through which data from the fixed sensor devices 121, 122 may be transmitted, or the fixed sensor devices 121, 122 may transmit data directly to a remote server, such as a authentication server 130.

An authentication server 130 is described providing cross-validation of the user 110 at the first location 112.

The authentication server 130 may include a mobile device request receiving component 131 for receiving a request from the user 110 via his mobile device 111 to obtain access through the security protection.

The mobile device 111 may include audio/visual or other data capture equipment such as a camera, microphone, touch-screen, etc. Captured signals (for example, speech or image signals) may be sent to the authentication server 130 where biometric data may be extracted from the captured data, for example, a person's voice, image (including face, iris, hair color, etc.), gestures, or other biometric data.

A mobile device data receiving component 132 may be provided at the authentication server 130 for receiving the user's captured signals as well as other entered user data such as a password or personal information. The received data may also include biometric data that has been already extracted on the mobile device 111.

The data received may be fed into a multifactor biometric authentication component 134 providing an accurate authentication of the user. The multifactor biometric authentication component 134 may output a verification score.

The first location 112 may be determined by GPS data of the mobile device 111. A location detector 135 may optionally be provided at the authentication server 130 to detect the second location 123, for example, using the user's request which may provide the second location 123 due to the access requested, or using GPS data of the mobile device 111 at the first location 112 and deducing that the user 110 is in close proximity to the second location 123.

The choice of fixed sensor devices 121, 122 to be monitored may be determined either by the type of access requested (e.g. “east door of building 5”) or by location information (e.g. GPS) provided by the mobile device as part of the access request.

A sensor mapping component 136 may be provided to map the determined second location 123 of the user 110 to local fixed sensor devices 121, 122 at the second location 123.

A fixed sensor data receiving component 133 may be provided at the authentication server 130 to receive data from the one or more local fixed sensor devices 121, 122. The data may be sent to the authentication server 130 via a secure connection or via a fixed surveillance system 120.

The fixed sensor devices 121, 122 may be used to provide highly accurate context information (time and location) for the authentication process. In addition, they may provide authentication data to be cross-validated with the mobile device data.

The level of authentication data from the fixed sensor devices 121, 122 may vary. At a minimum, a camera may check for the presence of at least some person at the second location 123, and/or the intercom station may verify that speech was being heard. At a higher level, existing fixed sensor devices 121, 122 may be used to perform a biometric authentication, albeit at a lower accuracy due to the quality of the fixed sensors (e.g. door microphone or nearby surveillance camera). This can be used as a “sanity check” against the more accurate authentication performed using the signals from the mobile device 111 to guard against device client programs that have been hacked to always provide positive authentications. Alternatively, the existing fixed sensor devices 121, 122 may be used to perform cross validation of the data from the mobile device 111.

The authentication server 130 may include a cross-validation component 140 including cross-validation authentication component 141, an optional challenge component 143, and a decision component 142.

The cross-validation authentication component 141 may cross-correlate the data from the mobile device 111 such as the user's voice, image or video with the local signals from the closest fixed sensor devices 121, 122. This may include certain signal processing steps in order to align the inputs in space and time followed by a cross-correlation procedure, which produces a score on how similar the inputs are from the two sources. The cross-validation authentication component 141 may also check other factors such as a current GPS location of the mobile device 111 compared to the second physical location 123.

The decision component 142 may provide an authentication decision. The decision component 142 may receive the outputs of the multifactor biometric authentication component 134 and the cross-validation authentication component 141, typically in the form of scores, and makes the authentication decision. The decision may take into consideration various factors such as the required security level at that time and place, confidence levels, claimed person's identity, etc.

In addition, an authentication policy provided at the decision component 142 may be based on different factors and thresholds, such as the required security level at that time and place, quality of the sensor information, specific situation/scenario, environment parameters, verified person ID or confidence level. For instance, depending on “security level” of a building, information from the same sensors may be processed differently, and with different thresholds levels for authentication, and possibly cross-validated with more sensors to increase the security level.

Cross-validation procedure based on signal matching is known in the art for matching two audio/video/image signals from separate channels in order to validate that they came from the same source.

Even though the use of multifactor biometrics verifies the identity of the phone user 110 with good confidence, confirming that the user 110 and the mobile device 111 are located at a designated location may require a further authenticating step.

Correlating the mobile device 111 and fixed sensors 121, 122 both visually and in an auditory manner improves determining the location of the mobile device 111, but may still be spoofed by an imposter located at the site and a cooperating user which has the mobile device 111 but at a separate remote location.

An optional challenge component 143 may provide additional verification that the mobile device 111 is at the first location 112 which is in close proximity to the second location 123. The challenge component 143 may generate challenge information which may be transferred securely to one of the mobile device 111 and a fixed surveillance system 120.

The fixed surveillance system 120 may present the challenge information (e.g. visually on the screen or vocally by using the intercom speaker), and the user 110 may be requested to use his mobile device to capture the said image (text, number string, color, . . . ) or/and said sound (speech, music, tone, noise, . . . ) as presented by the fixed surveillance system 120 and send it back to the server 130 so that it may be compared to the original challenge information.

Alternatively, the mobile device 111 may present the challenge information provided by the challenge component 143 of the server 130 and the fixed surveillance system 120 may capture the mobile device 111 output and send it back to the server 130 for comparison For example, the challenge information may be expressed as a visual token (e.g. color, picture, number, text) and it should be displayed on the mobile device 111 and seen by a fixed camera or the fixed surveillance system 120. Alternatively, when a microphone is available, an auditory token (noise, music, speech, tone) may be voiced through the mobile device speaker and it should be captured by the fixed microphone.

The challenge information may be replaced regularly, for example, by a quasi-random sequence, with use time as rapid as a single use, thus being impossible to predict.

The comparison between the captured information and original or expected information may be carried out by a comparison unit of the challenge component 143, which may be based on signal matching techniques known in the art.

For completeness, other methods for locality determination may be used independently such as Near Field Communication (NFC), Wi-Fi or Bluetooth. Where a fixed surveillance system has a presence sensor (of any type), it may be used to detect the mobile device in the proximity of the said location. The mobile device is determined to be in the said location and needs to be augmented with the user identity.

Other modalities may be used with the methods described above. The user may transfer accelerometer output from the mobile device. Double integration of the accelerometer output can then provide the spatial path of the mobile device, which can then be compared to the mobile device location as estimated using the fixed camera recording. Beam forming, a technique used with sensors array for either directional transmission or reception, may be used to pinpoint the location of the phone.

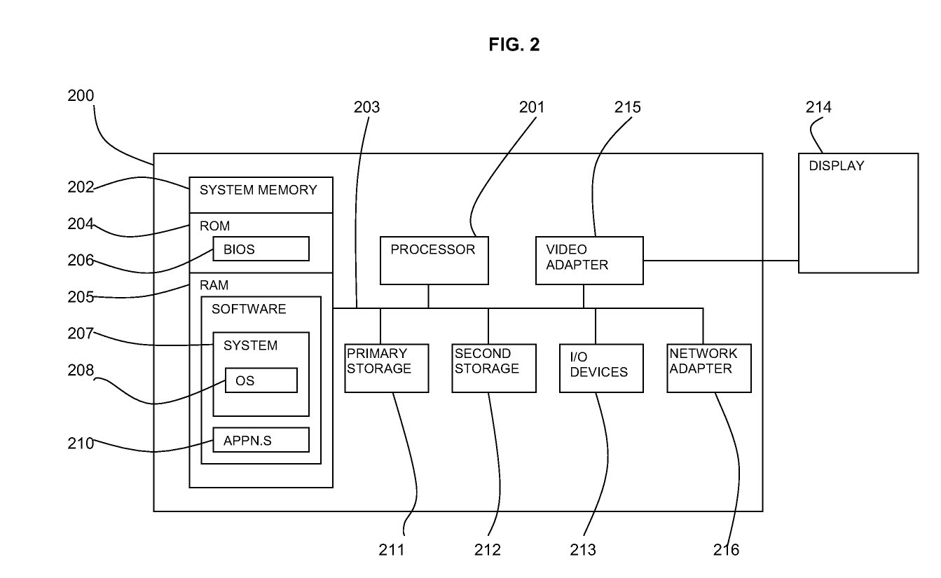

Referring to FIG. 2, an exemplary system for implementing aspects of the invention includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

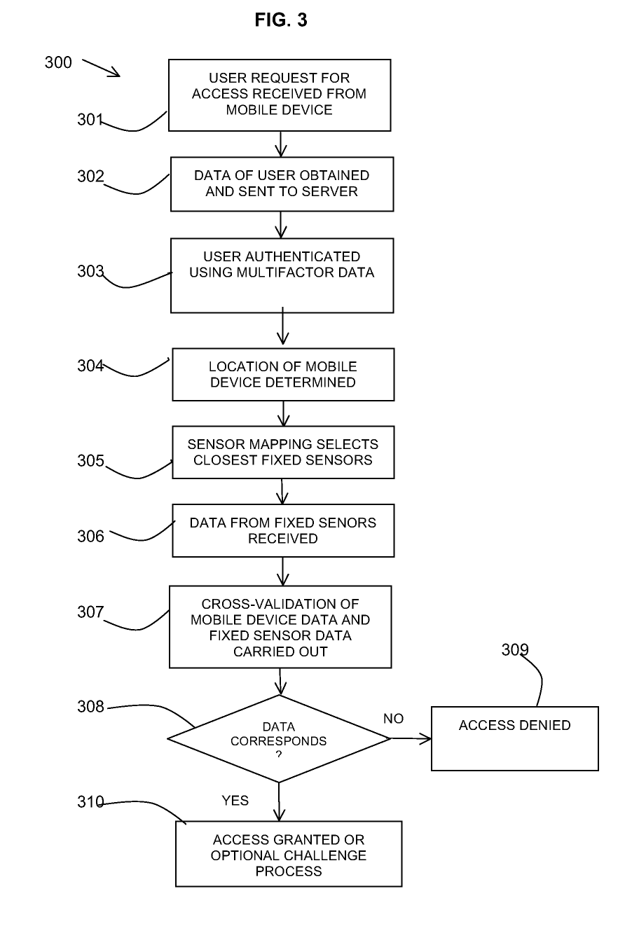

Referring to FIG. 3, a flow diagram 300 shows an example of the described method as carried out by an authentication server for secure facilities access.

A user request for access may be received 301 from the user's mobile device for access to a secure facility such as a security protected location, facility, or other physical location, etc. The user request may be sent by a message or other communication form from the user's mobile device.

Data of the user to be used in multifactor biometric authentication may be obtained 302 by the user's mobile device. The mobile device may capture audio, visual or other data from the user. The captured user data may be sent to the authentication server where user authentication may be carried out 303 including multifactor biometric authentication.

User authentication may be carried out 303 using the multifactor data comprising the sensor based user data and, optionally, other data from the user such as passwords, user GPS location, personal information, etc. The multifactor data may be sent from the mobile device to the authentication server where it is processed and the results obtained. Alternatively, the authentication may be carried out at the mobile device of the user and the results sent to an authentication server. In this case, some or all of the multifactor biometric data may also be sent to the authentication server for cross-validation as described below.

The location of the mobile device may be determined 304. For example, positioning technology may be used such as GPS to determine the location of the mobile device.

A sensor mapping may select 305 the closest fixed sensor devices to the position of the mobile device. For example, there may be one or more cameras, microphones, or other sensors in the vicinity. Alternatively, the closest fixed sensor devices may be determined from the content of the user's access request which may specify the location of the access requested.

Data from one or more of the fixed sensor devices is received 306. This data may include context information such as time and location, and may, in addition, include some authentication data such as voice, image, etc.

A cross-validation may be carried out 307 between the data from the mobile device and the fixed sensor data. For example, the voice inputs from the mobile device and a fixed sensor device may be compared, or a face image from both sources may be compared. The cross-validation may include certain signal processing steps in order align the inputs in space and time followed by a cross-correlation procedure, which produces a score on how similar the inputs are from the two sources.

It is determined 308 if the data corresponds. If it does not correspond, access may be denied 309 or further authentication required. If it does correspond, access may be granted or an optional additional challenge process carried out 310 as described below.

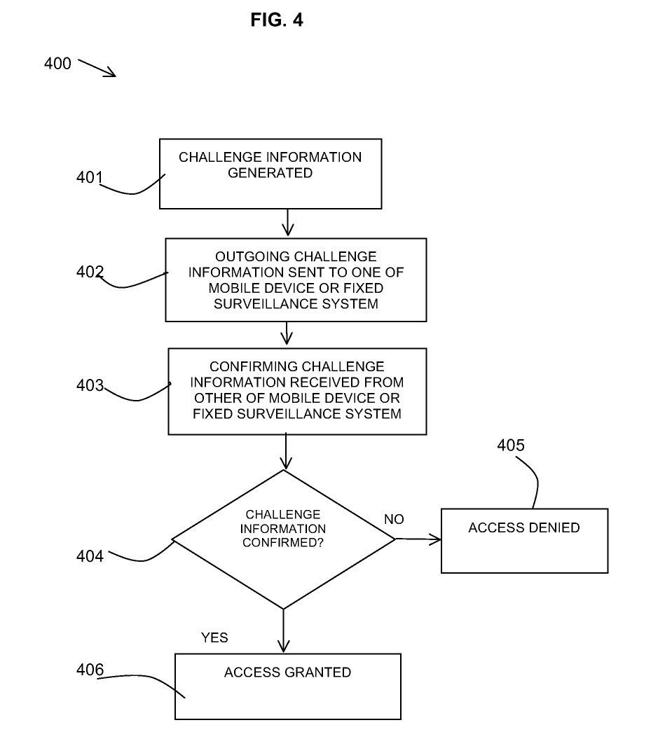

Referring to FIG. 4, a flow diagram 400 shows an example embodiment of a challenge process which may be provided as an additional verification that the mobile device is at the given location prior to granting access. The challenge process may be carried out prior to the cross-validation of the authentication data or after.

Challenge information may be generated 401. The outgoing challenge information may be sent 402 to one of the user's mobile device and a fixed surveillance system at the access location. The confirming challenge information may be received 403 from the other of the user's mobile device and the fixed surveillance system.

For example, the challenge information may be presented by the fixed surveillance system and the user via its mobile device may capture or respond to the challenge information.

In an alternative example, the challenge information may be sent to the user's mobile device and the fixed surveillance system may capture or respond to the challenge information.

A comparison of the sent and received challenge information may be carried out and the challenge information confirmed 404. If the challenge information is not confirmed, access may be denied or further verification required 405. If the challenge information is confirmed, access may be granted or further verification carried out as necessary.

A multifactor biometric authentication with localized validation system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for secure facilities access performed by a computerized device, comprising:
receiving an access request from a mobile device to access a secure facility;
authenticating a user using multifactor biometric authentication with data from the mobile device;
obtaining data from one or more fixed sensor devices at a location in the physical vicinity of the secure facility;
cross-validating data from the mobile device with data from the one or more fixed sensor devices; and
granting access to the secure facility if the authentication of the user and the cross-validation are successful.

2. The method as claimed in claim 1, including:
cross-validating that the access request from the mobile device is made in the vicinity of the secure facility using data from the one or more fixed sensor devices.

3. The method as claimed in claim 1, including:
determining a position of the mobile device;
selecting one or more fixed sensor devices closest to the position of the mobile device.

4. The method as claimed in claim 1, including:
determining the position of the secure facility by the content of the access request;
selecting one or more fixed sensor devices closest to the secure facility.

5. The method as claimed in claim 1, wherein authenticating a user using multifactor biometric authentication with data from the mobile device, includes:
receiving signals at a remote server captured using sensors embedded in the mobile device; and
carrying out a multifactor biometric authentication process on the remote server.

6. The method as claimed in claim 1, wherein authenticating a user using multifactor biometric authentication with data from the mobile device, includes:
receiving authentication results from a multifactor biometric authentication process carried out at the mobile device.

7. The method as claimed in claim 1, including:
receiving context data from the one or more fixed sensor devices including a presence or absence indication of the user; and wherein
the cross-validation checks the presence of the user according to presence indications of the one or more fixed sensing devices.

8. The method as claimed in claim 1, wherein cross-validating data from the mobile device with data from the one or more fixed sensor devices compares signals from the fixed sensor devices with the corresponding signals from the mobile device.

9. The method as claimed in claim 1, including:
issuing outgoing challenge information to one of the mobile device or a fixed surveillance system at the secure facility;
receiving confirming challenge information from the other of the mobile device or the fixed surveillance system;
comparing the outgoing challenge information and the confirming challenge information for verification that the mobile device is at the secure facility.

10. A computer program product for secure facilities access, the computer program product comprising:
a computer readable non-transitory storage medium having computer readable program code embodied therewith, the computer readable program code comprising:
computer readable program code configured to:
receive an access request from a mobile device to access a secure facility;
authenticate a user using multifactor biometric authentication with data from the mobile device;
obtain data from one or more fixed sensor devices at a location in the physical vicinity of the secure facility;
cross-validate data from the mobile device with data from the one or more fixed sensor devices;
grant access to the secure facility if the authentication of the user and the cross-validation are successful.

11. A system for secure facilities access, comprising:
a processor;
a mobile device request receiving component for receiving an access request from a mobile device to access a secure facility;
a multifactor biometric authentication component for authenticating a user using multifactor biometric authentication with data from the mobile device;
a fixed sensor data receiving component for receiving data from one or more fixed sensor devices at a location in the physical vicinity of the secure facility;
a cross-validation component for cross-validating data from the mobile device with data from the one or more fixed sensor devices; and
a decision component for granting access to the secure facility if the authentication of the user and the cross-validation are successful.

12. The system as claimed in claim 11, wherein the cross-validation component is for cross-validating that the access request from the mobile device is made in the vicinity of the secure facility using data from the one or more fixed sensor devices.

13. The system as claimed in claim 11, including:
a location detector for determining a position of the mobile device; and
a sensor mapping component for selecting one or more fixed sensor devices closest to the position of the mobile device.

14. The system as claimed in claim 11, including:
a location detector for determining the position of the secure facility by the content of the access request; and
a sensor mapping component for selecting one or more fixed sensor devices closest to the secure facility.

15. The system as claimed in claim 11, wherein the a multifactor biometric authentication component is for processing received signals captured using sensors embedded in the mobile device carrying out a multifactor biometric authentication process.

16. The system as claimed in claim 11, wherein the multifactor biometric authentication component is for receiving authentication results from a multifactor biometric authentication process carried out at the mobile device.

17. The system as claimed in claim 12, wherein a fixed sensor data receiving component is for receiving context data from the one or more fixed sensor devices including a presence or absence indication of the user; the cross-validation component is for checking the presence of the user according to presence indications of the one or more fixed sensing devices.

18. The system as claimed in claim 11, wherein the cross-validation authentication component compares signals from the fixed sensor devices with the corresponding signals from the mobile device.

19. The system as claimed in claim 11, wherein the cross-validation component includes:
a challenge component for:
issuing outgoing challenge information to one of the mobile device or a fixed surveillance system at the secure location;
receiving confirming challenge information from the other of the mobile device or the fixed surveillance system;
comparing the outgoing challenge information and the confirming challenge information for verification that the mobile device is at the secure facility.

20. A method of providing a service to a customer over a network, the service comprising:
receiving an access request from a mobile device to access a secure facility;
authenticating a user using multifactor biometric authentication with data from the mobile device;
obtaining data from one or more fixed sensor devices at a location in the physical vicinity of the secure facility;
cross-validating data from the mobile device with data from the one or more fixed sensor devices;
granting access to the secure facility if the authentication of the user and the cross-validation are successful.
